(19) United States
(12) Patent Application Publication
(10) Pub. No.: US 2007/0215538 A1
(43) Pub. Date: Sep. 20, 2007

(54) Systems and methods for equilibrium dialysis

(75) Inventors: Cecily J. Periana, Cambridge, MA (US); Mark Davis, Millville, MA (US); Ron Sostek, Newton, MA (US)

Correspondence Address: WILMER CUTLER PICKERING HALE AND DORR LLP, 1875 PENNSYLVANIA AVE., NW, WASHINGTON, DC, 20004, US

(73) Assignee: Harvard Apparatus, Inc., Holliston, MA (US)

(21) Appl. No.: 11/378,484

(22) Filed: Mar. 20, 2006

(51) Int. Cl. B01D 63/00

(52) U.S. Cl. 210/321.6; 210/500.1; 210/500.27; 422/101

(57) ABSTRACT

This invention relates to equilibrium dialysis systems and methods. More particularly, the invention relates to pre-assembled or ready-to-use single-well or multi-well dialysis systems that are disposable in their entirety, comprising a molded block for performing equilibrium dialysis of one or more samples. Such equilibrium dialysis systems can be used for protein binding assays, molecule-molecule interaction studies, tissue cultures and many other biological and chemical applications. Such equilibrium dialysis systems are suitable for use in manual or high throughput formats.

### FIELD OF THE INVENTION

This invention relates to equilibrium dialysis systems and methods. More particularly, the invention relates to pre-assembled or ready-to-use single-well or multi-well dialysis systems that are disposable in their entirety, comprising a molded block for performing equilibrium dialysis of one or more samples. Such equilibrium dialysis systems can be used for protein binding assays, molecule-molecule interaction studies, tissue cultures and many other biological and chemical applications, including high throughput or manual screening.

### BACKGROUND OF THE INVENTION

The present invention relates to an equilibrium dialysis system comprising a molded block for performing interaction studies and assays on one or more samples. In a standard equilibrium dialysis system, a semi-permeable membrane is placed between two sample compartments, allowing the flow of small molecules through the membrane. With rapid progress in new drug screening and discovery and advances in biomedical research, equilibrium dialysis is becoming an increasingly important technique for protein binding assays, molecule-molecule interaction studies, tissue cultures, and many other biological and chemical applications. Equilibrium dialysis is frequently used in new drug discovery methods, and can also be used to study DNA-protein interactions; receptor binding assays of free analytes, such as T3/T4, cortisol, and free testosterone, in serum; drug binding; and many other interactions between larger biomolecules and other smaller molecules.

Novel drug discovery and biomedical research applications, such as high throughput screening, require simultaneous processing of large numbers of test samples for the rapid purification and identification of desired molecules and drug candidates. In such applications, millions of samples may have to be screened using techniques such as equilibrium dialysis. Therefore, there is a need for rapid screening of large numbers of samples.

Currently, several types of equilibrium dialyzers are used. But, the equilibrium dialyzers commercially available require manual assembly by the user and are not disposable. For example, one currently available device allowing for simultaneous testing of up to twenty samples requires assembly and is difficult to use since it requires, because of its design, samples to be inserted and withdrawn manually from the compartments with a syringe. Other available devices allow for testing of up to 96 samples. However these devices also require assembly and are not disposable. For example, one device consists of nine Teflon® blocks separated by membranes that need to be aligned and then carefully clamped together to form a unified leak-proof body. An example of a known device is described in U.S. Pat. No. 6,776,908. Another device consisting of a reusable Teflon® base plate that can accommodate up to 48 equilibrium dialysis inserts also requires some assembly, disassembly and cleaning. Hence, there is a need in the art for an equilibrium dialysis system that is single-well or multi-well, ready-to-use and disposable, requiring no assembly, and is easy to use in a high throughput format. Accordingly, the present invention is directed to these, as well as other, important ends.

### SUMMARY OF THE INVENTION

The present invention provides equilibrium dialysis systems comprising a molded block; at least one sample chamber in the block; and a semipermeable membrane placed in the sample chamber to form a first compartment having a port and a second compartment having a port, wherein the port of the first compartment and the port of the second compartment are located on one side of the molded block. In one or more embodiments, the at least one sample chamber has a water repellant and biocidal coating on the inner surface of the chamber. In further embodiments, the molded block further comprises a layer of conductive coating material on the outer surface of the block. The conductive coating may comprise, for example, indium tin oxide or a metallic coating.

The molded block can be composed of one or more materials selected from a group consisting of polytetrafluoroethylene, cellulose acetate, polysulfone, polyethylene, polyethersulfone, polypropylene, polyetheretherketone, polymethyl methacrylate, polystyrene, polystyrene/acrylonitrile copolymer, polyvinylidenefluoride, elastomer, and silicones and silicates. The semi-permeable membrane can be composed of one or more materials selected from a group consisting of cellulose, cellulose acetate, polytetrafluoroethylene, polysulphone, nitrocellulose and polycarbonate.

In some embodiments of the invention, the first compartment and the second compartment further comprise closures for sealing the open ends. The sample chamber may hold volumes of about 1 microliter to about 5000 microliters. In some embodiments, the volume of the first compartment is equal to the volume of the second compartment, and in other embodiments the volume of the first compartment is not equal to the volume of the second compartment. In some embodiments, the first compartment and the second compartment have the same shape or a different shape. Preferably, the first compartment and the second compartment are in a size and shape suitable for manual or automatic sample preparation. In yet other embodiments, the first compartment and/or second compartment is physically or chemically modified with at least one material selected from a chromatographic material, an enzyme, an antibody, a cyclodextrin, a lectin, a metal ion, and a ligand.

The invention also provides equilibrium dialysis systems comprising a preassembled molded block disposable in its entirety; at least one sample chamber in the block having a water repellant and biocidal coating on the inner surface of the chamber; and a semipermeable membrane placed in the sample chamber to form a first compartment having a port and a second compartment having a port, wherein the port of the first compartment and the port of the second compartment are located on one side of the molded block.

The systems of the invention are useful for applications such as protein binding assays, molecule-molecule interaction studies, tissue culturing, other biological applications, other chemical applications, and high throughput screening.

The invention also provides kits comprising the equilibrium dialysis systems.

### BRIEF DESCRIPTION OF DRAWINGS

FIG. 1(A) is a diagram illustrating the top of one embodiment of an equilibrium dialysis system according to the present invention;

FIG. 1(B) is a diagram illustrating a side view of one embodiment of a horizontal cross-section of an equilibrium dialysis system according to the present invention; and

FIG. 2 is a diagram illustrating an expanded view of one embodiment of a vertical cross-section of a single row of wells of an equilibrium dialysis system according to the present invention.

### DETAILED DESCRIPTION OF THE INVENTION

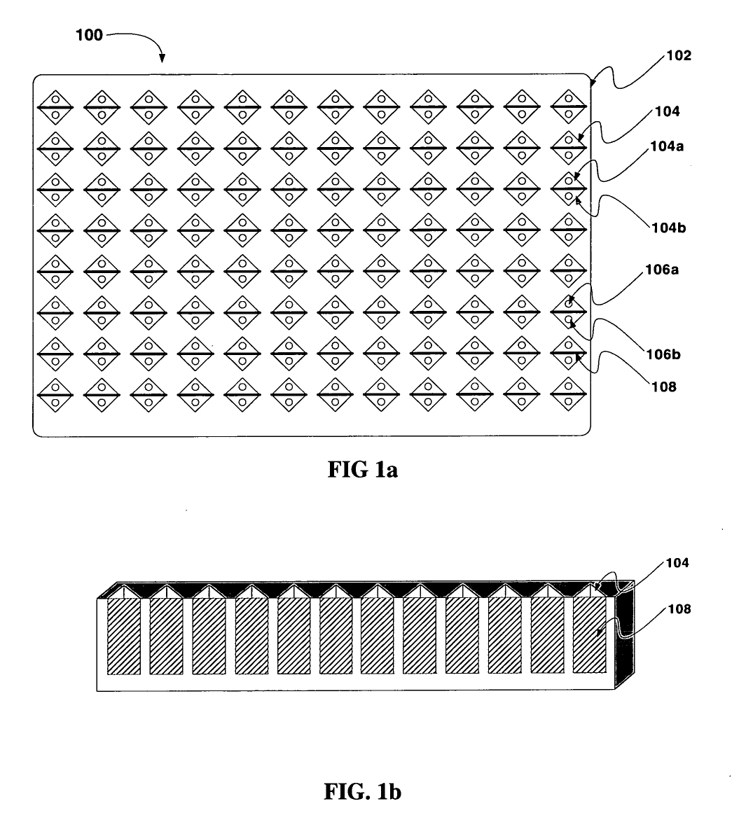

Embodiments of the present invention provide ready-to-use and fully disposable equilibrium dialysis systems that are suitable for use in robotic or automated systems. Referring now to the drawings, and more particularly to FIG. 1A, there is shown a top view of one embodiment of an equilibrium dialysis system, generally designated 100. System 100 includes at least one block 102, at least one sample chamber or well 104, and at least one semi-permeable membrane 108, each as described in reference to FIG. 1A.

In one example of the present invention, equilibrium dialysis system 100 can be formed from a single molded block 102 of one or more materials. Block 102 can be made of one or more moldable materials selected from cellulose acetate, polysulfones, polyethersulfones, polyethylene, polypropylenes, polyetheretherketones, polymethyl methacrylates, polystyrenes, polystyrene/acrylonitrile copolymers, polyvinylidenefluorides (PVDF), elastomers, silicones and silicates, and the like.

The molded block can be manufactured using processes known to the skilled artisan. In one example, two pre-cast steel molds are pushed together, and a molten, moldable material is introduced into the molds. After the moldable material solidifies in the molds, the molds are removed to form the molded block. The semi-permeable membrane can be placed between the two halves of the molded block while the halves are still in the molds or after the molds are removed. In one example embodiment, an adhesive material is applied to channels carved into each mold, forming adhesive gaskets for bonding to either side of the membrane. In another example embodiment, the two halves of the molded block are held together using integral pinch clamps. In another example embodiment, the membrane is locked between the two halves of the molten block with both adhesive gaskets and integral pinch clamps.

In one embodiment, block 102 comprises at least one sample chamber or well. In another embodiment, block 102 comprises at least 96 sample chambers. In another embodiment, block 102 comprises at least 768 sample chambers. In another embodiment, block 102 comprises at least 1536 sample chambers. In yet another embodiment, block 102 is comprises up to one million or more sample chambers.

Individual sample chambers 104 are arranged in an array on block 102 and include ports 106 to provide access to each sample chamber 104. In one example, shown in FIG. 1A, 96 sample chambers are arranged in an 8×12 array on block 102. Sample chamber 104 can be of any shape or size suitable for manual or automatic sample preparation. In one example, the shape of each sample chamber 104 can all be one shape. In another example, the shapes of the sample chambers can be a combination of different shapes. The shape of each sample chamber can independently be, for example, a cube, cylinder, rectangular prism, pentagonal prism, triangular prism, hexagonal prism, cone, pyramid, tetrahedron, and the like.

Interior surface of sample chamber 104 is optionally coated with at least one water repellant and biocidal material. In one example, at least one polymeric material is selected from polytetrafluoroethylenes (e.g., TEFLON® by DuPont), cellulose acetate, polysulfones, polyethersulfones, polyethylenes, polypropylenes, polyetheretherketones, polymethyl methacrylates, polystyrenes, polystyrene/acrylonitrile copolymers, polyvinylidenefluorides (PVDF), elastomers, silicones, silicates, and the like. The coating can also include functional absorbants with or without a support matrix, such as C₁₈, polyethylene glycols (PEGs), and NH₂ functional groups.

Exterior surface of block 102 is optionally coated with metallic oxides, conductive ceramics, or other resistance causing materials used for temperature control. In one example, block 102 is coated with indium tin oxide. The coating can also include metallic materials that are used for heating and cooling samples.

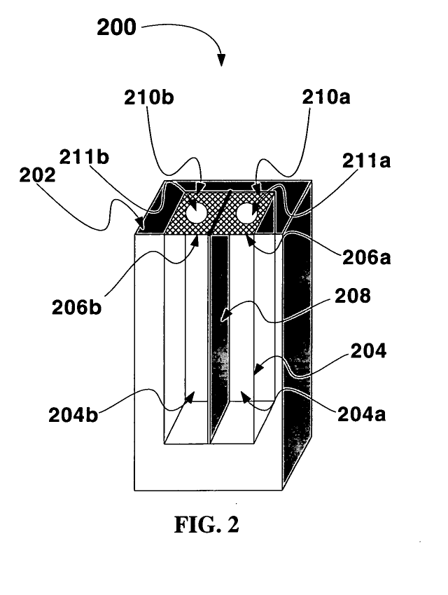

Semi-permeable membrane 108 is placed in individual sample chamber 104 to form compartment 104a having a port 106a and second compartment 104b having a port 106b. In one example embodiment, semi-permeable membrane 108 is disposed diagonally in rectangular sample chamber 104 (shown in FIG. 1B). In another example embodiment, semi-permeable membrane 108 is disposed parallel to the side of rectangular sample chamber 104 (shown in FIG. 2).

Semi-permeable membrane 108 may be of any molecular weight cut-off (MWCO) known in the art, and may be of any material for separation techniques known in the art. Exemplary MWCOs are, for example, from 100 Daltons to 10 million Daltons. Semi-permeable membrane 108 may have MWCOs of, for example, 100 Daltons, 500 Daltons, 1,000 Daltons, 2,000 Daltons, 5,000 Daltons, 10,000 Daltons, 25,000 Daltons, 50,000 Daltons, 100,000 Daltons, or 300,000 Daltons. Alternatively, semi-permeable membrane 108 may have a pore size between about 0.01 microns to about 1 micron. Semi-permeable membrane 108 may have pore sizes of, for example, 0.01 microns, 0.05 microns or 0.60 microns. Semi-permeable membrane 108 may be made from one or materials from the group consisting of cellulose, cellulose acetate, Teflon, polysulphone, nitrocellulose and polycarbonate. Each well or sample chamber in the multi-well equilibrium dialysis systems of the invention may have membranes that have different MWCOs and/or that are made of different semi-permeable or porous materials.

Semi-permeable membrane 108 can be placed between the two compartments 104a-b by any physical or chemical method known in the art. Physical and chemical methods for placing the membrane between the two chambers include, for example, physical placement, adhesion, bonding, chemical attachment, and/or heat-based sealing. Physical placement may involve using all or part of the first and second compartments to guide the membrane into place, and then physically locking the first and second compartments into place. This lock fit optionally includes placement of leak-proof materials to be used for sealing or compression actions, including any material that can form a tight seal. Adhesion sealing may involve applying adhesives, such as cyanoacrylate, acrylic, urethane, epoxy or silicone, to the first compartment, second compartment, and/or membrane to secure the membrane into place. Bonding may involve pressure, UV, microwave or ultra-sound to attach the membrane to the first and/or second compartment. Heat-based sealing may involve melt bonding the membrane to the first and/or second compartment. Any combination of these or other methods may be used to lock the membrane between the first compartment and the second compartment.

The inside walls of first compartment 104a and second compartment 104b may independently and optionally be physically and/or chemically modified with any functional group known in the art. For example, the inside walls of the first compartment and/or second compartment may each independently and optionally be physically and/or chemically modified with chromatographic materials, enzymes, antibodies, cyclodextrins, lectins, metal ions, and/or ligands. In other embodiments, the inside walls of the first and/or second compartment may each independently and optionally by physically and/or chemically modified with, for example, poly-L-lysine, poly-D-lysine, DEAE-dextran, poly-L-arginine, poly-L-histidine, poly-DL-ornithine, protamine, collagen type 1, collagen type IV, gelatin, fibronectin, laminin, chondronectin, and the like.

The enzymes, antibodies, cyclodextrins, lectins, metal ions and ligands may be any known in the art. The chromatographic materials may be any known in the art, including, for example, materials for ion-exchange chromatography, size-exclusion chromatography, affinity chromatography, gradient chromatography, hydrophobic chromatography, chiral chromatography, and mixtures thereof. Exemplary chromatographic materials include polysaccharides (e.g., cellulose, agarose, crosslinked polysaccharide beads (commercially available as SEPHAROSE® and SEPHADEX®)), polymers (e.g., polystyrene, polytetrafluoroethylenes (PTFE) (e.g., TEFLON® from DuPont), styrenedivinyl-benzene based media, polymer beads, PMMA (PERSPEX®), polyacrylamide), silicas (e.g., silica, silica gel, silica gel-containing phosphors, glass, controlled pore glass (CPG)), or metals (e.g., aluminum oxide, zirconium, titanium). The chromatographic materials can be chemically and/or physically modified, and may be porous or non-porous. For example, styrenedivinyl-benzene based media may be modified with, for example, sulphonic acids, quarternary amines and the like. Silicas (e.g., silica, silica gel, silica gel-containing phosphors, glass, CPG) may be modified with, for example, C₂, C₄, C₆, C₈ or C₁₈ or ion exchange functionalities. Chromatographic materials may be physically modified with, for example, enzymes, antibodies, cyclodextrins, lectins, metal ions, and/or ligands. The chromatographic materials may have any regular (e.g., spherical) or irregular shape, or may be shards, fibers, powders or mixtures thereof.

The volume ratio of first compartment 104a to second compartment 104b may be varied, for example, from about 1:1 to about 5,000:1. The volume ratio of compartment 104a and second compartment 104b may range from about 10:1 to about 200:1; or from about 50:1 to about 200:1; or from about 25:1 to about 300:1; or from about 500:1 to about 1,500:1; or from about 3,000:1 to about 5,000:1. In preferred embodiments, the volume ratio of compartment 104a and second compartment 104b may be from about 75:1 to about 250:1, or from about 200:1 to about 250:1.

FIG. 2, generally at 200, shows a vertical cross-sectional view of one example embodiment of individual sample chamber 204 in block 202. In one embodiment, semi-permeable membrane 208 is placed in sample chamber 204 to form first compartment 204a and second compartment 204b. First compartment 204a and second compartment 204b can be of the same or different shapes and sizes. In one example of the present invention, port 206a in open end 211a of first compartment 204a and port 206b in open end 211b of second compartment 204b are sealed with closures 210a-b. Closures 210a-b can also be made of one or more materials selected from polytetrafluoroethylene, polysulfone, polyethersulfone, cellulose acetate, polystyrene, polystyrene/acrylonitrile copolymer, PVDF and glass.

Closures 210a-b can be of the same or different shapes and sizes. Each of the closures may be part of a multi-well closure designed to close all wells of the equilibrium dialysis system simultaneously or may be part of a closure system designed to close only selected wells in the system. Closures 210a-b may also be part of an adhesive sheet, strip, mat, or layer. Closures 210a-b can also be self-sealing such that the closure will seal after the delivery of sample through the closure into the sample chamber 204. The samples can be placed into or removed from sample chamber 204 using a syringe, needle or other penetrating mechanism that eliminates the need to attach or remove the closures after sample placement or prior to sample retrieval, respectively. Thus, the open ends of the chambers may also be temporarily or permanently closed ends. Closures 210a-b may be removably attached or permanently attached to the system.

Interior surface of sample chamber 204 is optionally coated with at least one water repellant and biocidal material. In one example, at least one polymeric material is selected from polytetrafluoroethylenes (e.g., TEFLON® by DuPont), cellulose acetate, polysulfones, polyethylenes, polyethersulfones, polypropylenes, polyetheretherketones, polymethyl methacrylates, polystyrenes, polystyrene/acrylonitrile copolymers, polyvinylidenefluorides (PVDF), elastomers, silicones, silicates, and the like. The coating can also include functional absorbants with or without a support matrix, such as C₁₈, PEGs, and NH₂ functional groups.

The present invention also provides kits comprising the equilibrium dialysis systems described herein. The kits can comprise one or more well-systems, top closures, bottom closures, membranes, biocidal agents, growth blocks, reagents, buffers (e.g., lysis buffers, wash buffers), cells, filters, collection tubes, plate rotators, clamps, syringes, pipette tips, chromatographic materials, and user manuals. The term“kit” includes, for example, each of the components combined together in a single package, the components individually packaged and sold together, or the components presented together in a catalog (e.g., on the same page or double-page spread in the catalog).

With increasing needs in drug screening and discovery and advances in biomedical research, equilibrium dialysis is becoming an increasingly important technique for protein binding assays, molecule-molecule interaction studies, tissue cultures and many other biological and chemical applications, such as manual or high throughput screening.

To use the equilibrium dialysis system of the invention in a binding assay (e.g., receptor-ligand assay), one compartment of a sample chamber may be filled with a receptor sample (e.g., protein, organic or inorganic binders including cellulose, carbohydrates, plastics, particles, oils, ink and shale rock). The receptor sample contains molecules that are too large to pass through the pores of the membrane. The second compartment of the sample chamber is filled with a solution containing small molecules (e.g., ligand) that can pass through the pores of the membrane. Or, the small molecule is optionally added to the first compartment containing the receptor and a liquid would be added to the second compartment. When this system is allowed to equilibrate, the small molecules will be present in both compartments, i.e., on each side of the membrane. If the small molecules bind to the protein, the state of equilibrium will be affected such that more small molecules will be present both as bound and unbound or free in the receptor sample compartment than as free in the second compartment, but the concentration of free fraction is the same in both compartments. During and upon completion of equilibrium dialysis, quantitative and/or qualitative assays can be performed on the samples. This method is frequently used in new drug discovery methods and molecular interaction studies. By choosing appropriately-sized membranes, equilibrium dialysis may also be used to study DNA-protein interactions, protein-protein interactions, and many other interactions between bio-molecules and other molecules.

In cell culturing, the cells can be placed in one compartment of a sample chamber. Nutrients and other molecules can be added to the other compartment and be introduced to the cells through equilibrium dialysis. To study the interaction between small molecules and cells, small molecules can be added to one compartment and allowed to diffuse through the membrane and interact with the cells in the cell-containing compartment. During and upon completion of equilibrium dialysis, quantitative and/or qualitative assays can be performed to further study the samples.

For growing adherent cells, the cell-containing compartment may be made of a material that would provide a surface on which the cells could adhere (e.g., polystyrenes, polytetrafluoroethylenes, polyvinylchlorides, polycarbonates, titanium, or mixtures thereof). The material of the cell-containing compartment may further comprise coating agents, such as, for example, poly-L-lysine, poly-D-lysine, DEAE-dextran, poly-L-arginine, poly-L-histidine, poly-DL-ornithine, protamine, collagen type 1, collgen type IV, gelatin, fibronectin, laminin, chondronectin, and the like. Alternatively, the cell-containing compartment may contain a surface coating, such as the surface matrix coating described herein, which may further comprise coating agents, such as, for example, poly-L-lysine, poly-D-lysine, DEAE-dextran, poly-L-arginine, poly-L-histidine, poly-DL-ornithine, protamine, collagen type 1, collagen type IV, gelatin, fibronectin, laminin, chondronectin, and the like.

While specific embodiments of the invention have been shown and described in detail to illustrate the application of the principles of the invention, it is understood that the invention may be embodied otherwise without departing from such principles and that various modifications, alternate constructions, and equivalents will occur to those skilled in the area given the benefit of this disclosure and the embodiment described herein, as defined by the appended claims.

We claim:

1. An equilibrium dialysis system comprising:
a molded block;
at least one sample chamber in said block; and
a semipermeable membrane placed in the sample chamber to form a first compartment having a port and a second compartment having a port, wherein the port of the first compartment and the port of the second compartment are located on one side of the molded block.

2. The system of claim 1, wherein the at least one sample chamber comprises a water repellant and biocidal coating on the inner surface of said chamber.

3. The system of claim 1, wherein the molded block further comprises a layer of conductive coating material on the outer surface of said block.

4. The system of claim 3, wherein the conductive coating comprises indium tin oxide.

5. The system of claim 3, wherein the conductive coating comprises a metallic coating.

6. The system of claim 1, wherein the first compartment and the second compartment further comprises closures for sealing the open ends.

7. The system of claim 1, wherein the port of the first compartment and the port of the second compartment are located on the same side of the molded block.

8. The system of claim 1, wherein the sample chamber has a volume of about 1 microliter to about 5000 microliters.

9. The system of claim 1, wherein the block is composed of one or more materials selected from a group consisting of polytetrafluoroethylene, cellulose acetate, polysulfone, polyethylene, polyethersulfone, polypropylene, polyetheretherketone, polymethyl methacrylate, polystyrene, polystyrene/acrylonitrile copolymer, polyvinylidenefluoride, elastomer, silicones, and silicates.

10. The system of claim 1, wherein the semi-permeable membrane is composed of one or more materials selected from a group consisting of cellulose, cellulose acetate, polytetrafluoroethylene, polysulphone, nitrocellulose and polycarbonate.

11. The system of claim 1, wherein the system is used for an application selected from protein binding assays, molecule-molecule interaction studies, tissue culturing, high throughput screening, other biological applications, and other chemical applications.

12. The system of claim 1, wherein the volume of the first compartment is equal to the volume of the second compartment.

13. The system of claim 1, wherein the volume of the first compartment is not equal to the volume of the second compartment.

14. The system of claim 1, wherein the first compartment and the second compartment have the same shape or a different shape.

15. The system of claim 1, wherein the first compartment and the second compartment are in a size and shape suitable for manual or automatic sample preparation.

16. The system of claim 1, wherein the first compartment and/or second compartment is physically or chemically modified with at least one material selected from a chromatographic material, an enzyme, an antibody, a cyclodextrin, a lectin, a metal ion, and a ligand.

17. An equilibrium dialysis system comprising:
a molded block having a conductive coating on the outer surface of said block;
at least one sample chamber in said block having a water repellant and biocidal coating on the inner surface of said chamber; and
a semipermeable membrane placed in the sample chamber to form a first compartment having a port and a second compartment having a port, wherein the port of the first compartment and the port of the second compartment are located on one side of the molded block.

18. A kit comprising the system of claim 1 or claim 17.

19. An equilibrium dialysis system comprising:
a preassembled molded block disposable in its entirety;
at least one sample chamber in said block having a water repellant and biocidal coating on the inner surface of said chamber; and
a semipermeable membrane placed in the sample chamber to form a first compartment having a port and a second compartment having a port, wherein the port of the first compartment and the port of the second compartment are located on one side of the molded block.
